(19) United States
(12) Patent Application Publication
(10) Pub. No.: US 2014/0069944 A1
(43) Pub. Date: Mar. 13, 2014

(54) Cup Lid With Straw Crimping Mechanism

(71) Applicant: Mattel, Inc., El Segundo, CA (US)

(72) Inventors: David Shapiro, East Aurora, NY (US); Charlie Smith, East Amherst, NY (US)

(73) Assignee: Mattel, Inc., El Segundo, CA (US)

(21) Appl. No.: 14/021,291

(22) Filed: Sep. 9, 2013

Related U.S. Application Data
(60) Provisional application No. 61/699,598, filed on Sep. 11, 2012.

(51) Int. Cl. A61J 9/00

(52) U.S. Cl. CPC A61J 9/006
USPC 220/709

(57) ABSTRACT

An infant cup lid includes a base, a cap, and a straw. The base contains an aperture configured to receive a straw. Furthermore, the cap is rotatably coupled to the base and also includes an opening configured to receive the straw. Moreover, the base is configured to attached to a cup or container that contains fluid for consumption by a user. Through selective rotation of the cap about the base by a user, a portion of the straw is crimped or pinched, sealing the straw. This prevents the contents of the cup from spilling or leaking out of the cup, infant cup lid, or straw.

### CROSS REFERENCE TO RELATED APPLICATION AND CLAIM TO PRIORITY

This application claims priority under 35 U.S.C. 119(e) to U.S. Provisional Patent Application Ser. No. 61/699,598, entitled “Sippy Cup Soft Spout and Method for Forming the Same”, filed Sep. 11, 2012, the disclosure of which is incorporated herein by reference in its entirety for all purposes.

### FIELD OF THE INVENTION

The present invention relates to a lid to an infant's beverage container. More specifically, the present invention is an infant cup lid that includes a rotatable cap that crimps or pinches a drinking straw.

### BACKGROUND OF THE INVENTION

Various types of beverage containers exist for growing children. These infant beverage containers further include a variety of lids. Some lids include an open spout, while others include a sippy spout with valves to prevent leaking and spilling. Other lids include a straw that is configured to enable an infant to easily extract the contents out of the beverage container. Lids that are configured with straws or to receive straws, however, are prone to leaking and spilling, as most straws do not form a seal with the aperture in the lid. Furthermore, most straws do not contain a valve. While making it easier for a child to use the straw, even the inclusion of a valve within the straw does not fully prevent fluid from exiting the container through the straw when the beverage container is knocked-over or tipped upside down.

Therefore, what is needed is a lid to an infant beverage container that is capable of forming a seal to prevent leaking and spilling of the contents of the infant beverage container. Furthermore, what is needed is a straw and lid combination that provides easy access to the contents of the infant beverage container while still being capable of being securely sealed.

### SUMMARY OF THE INVENTION

According to one exemplary embodiment, the present invention includes an infant cup lid including a base, a cap rotatably coupled to the base, and a straw. In addition, the base contains an aperture sized to fit the straw. Similarly, the cap contains a hole at least large enough to fit the straw. Furthermore, the cap rotates about the base between an open position and a closed position. In the open position, the cap is oriented so the straw is in fluid communication with a cup to which the infant lid is attached. In the closed position, the cap is oriented so that the straw is pinched between the cap and the base, preventing fluid flow from the cup through the straw.

### BRIEF DESCRIPTION OF THE DRAWINGS

FIG. 1 illustrates a top view of a first embodiment of an infant cup lid according to the present invention.

FIG. 2 illustrates a top view of the embodiment of the infant cup lid illustrated in FIG. 1 with the cap removed.

FIG. 3 illustrates a top view of the embodiment of the infant cup lid illustrated in FIG. 1 with the cap rotated to another position.

FIG. 4 illustrates a perspective view of a second embodiment of an infant cup lid according to the present invention.

FIG. 5 illustrates a perspective view of the top of the base of the embodiment of the infant cup lid illustrated in FIG. 4.

FIG. 5a illustrates a perspective view of the bottom of the base illustrated in FIG. 5.

FIG. 6 illustrates a perspective view of the straw of the embodiment of the infant cup lid illustrated in FIG. 4.

FIG. 6a illustrates a cross-section of the straw illustrated in FIG. 6.

FIG. 7 illustrates a perspective view of the top of the straw coupled to the base of the embodiment of the infant cup lid illustrated in FIG. 4.

FIG. 7a illustrates a perspective view of the bottom of the straw coupled to the base illustrated in FIG. 7.

FIG. 8 illustrates a perspective view of the top of the cap of the embodiment of the infant cup lid illustrated in FIG. 4.

FIG. 8a illustrates a perspective view of the bottom of the cap illustrated in FIG. 8.

FIG. 9 illustrates a cross-sectional view of the embodiment of the infant cup lid illustrated in FIG. 4.

Like reference numerals have been used to identify like elements throughout this disclosure.

### DETAILED DESCRIPTION OF THE INVENTION

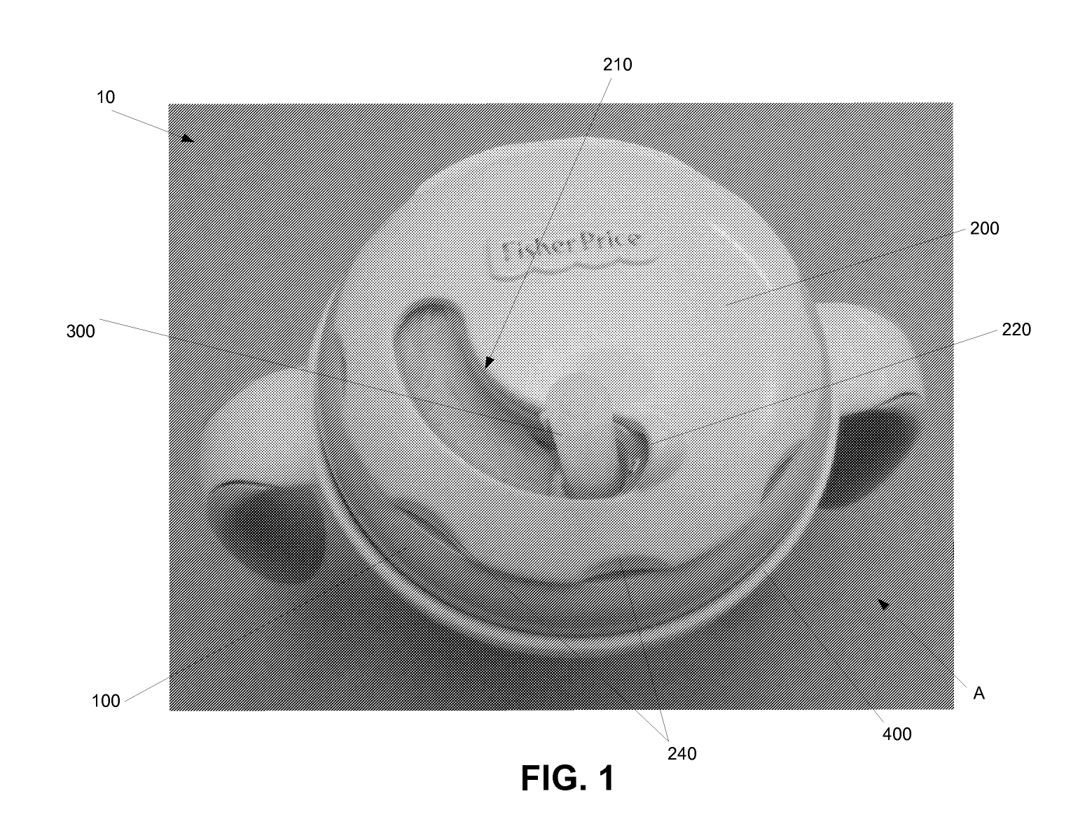

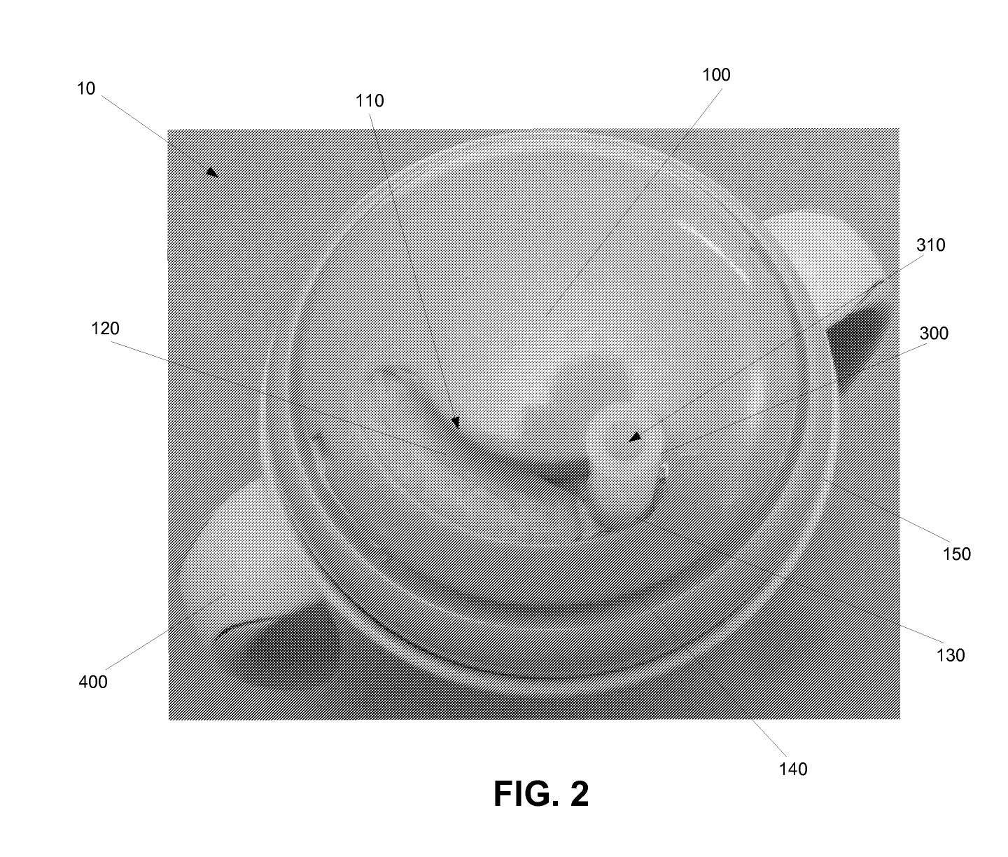

Referring to FIGS. 1 and 2, a top view of a first embodiment of the infant cup lid 10 in accordance with the present invention is illustrated. FIG. 1 illustrates a top view of the infant cup lid 10 with the cap 200 attached to the base 100. FIG. 2 illustrates a top view of the infant cup lid 10 without the cap 200, illustrating the details of the base 100. The infant cup lid includes a base 100, a cap 200, and a straw 300. As best illustrated in FIG. 2, the base 100 contains a curvilinear channel 110 along an inner portion of the base 100. The channel 110 has a curvature that follows the curvature of the edge of the base 100. Furthermore, the base 100 contains an aperture 130 located on one end of the channel 100, the aperture 130 has a diameter equal to the width of the channel 110. As illustrated by FIG. 2, the diameter of the aperture 130, and subsequently the width of the channel 110, is configured to receive the straw 300. In this embodiment, the straw 300 is configured to snuggly fit within the aperture 130 of the base 100, preventing fluid within the cup 400 from leaking through the aperture 130 around the straw 300. The straw 300 may be glued into the aperture 130 or frictionally fit within the aperture 130. In addition, a ramp 120 is located within the channel 110, the ramp 120 having an upward slope from the aperture 130 to the opposite end of the channel 110.

Additionally, in this embodiment, the base 100 includes a rim 150. The rim 150 includes internal threads (not shown) that mate with external threads (not shown) of the cup 400 to enable the infant cup lid 10 to be screwed onto the cup 400. In other embodiments, the infant cup lid 10 may be coupled to the cup 400 via a snap fit, friction fit, or other similar means.

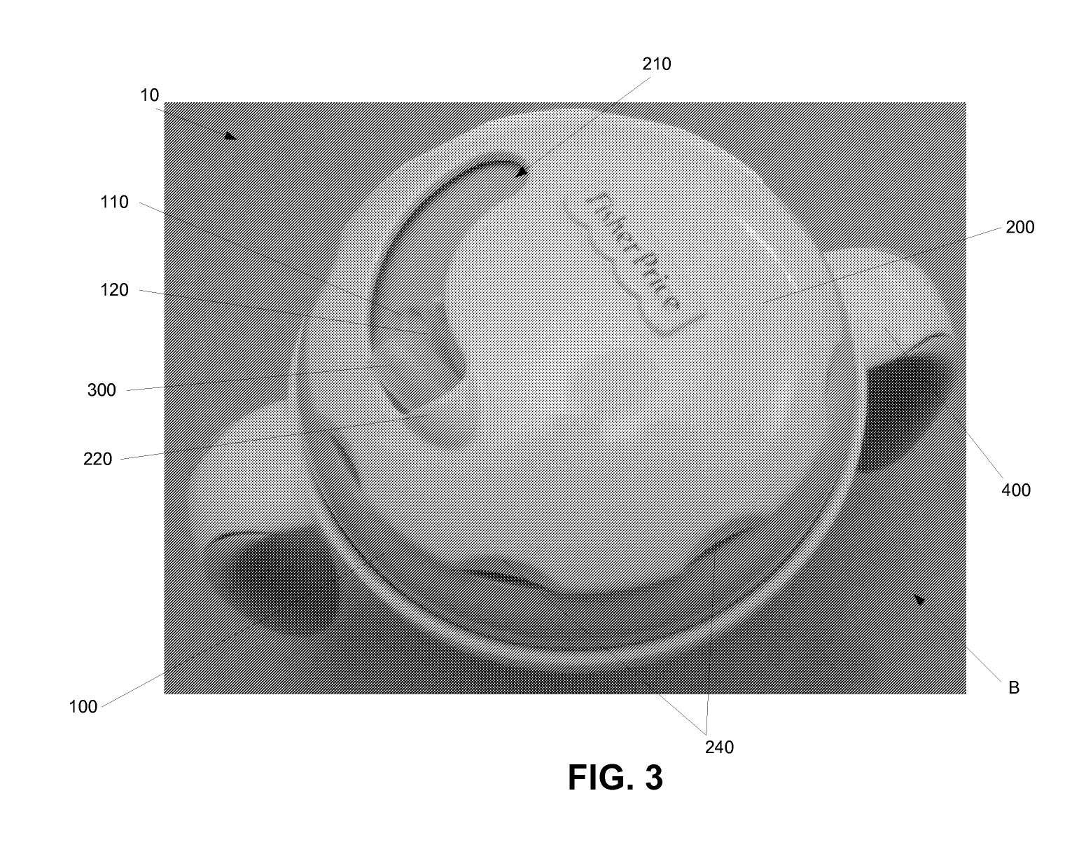

The cap 200 is rotatably coupled to the base 100 and covers a significant portion of the base 100 as illustrated in FIG. 1. As illustrated in FIG. 2, the base 100 contains a track 140 along at least a portion of its peripheral edge. The cap 200 includes a track runner (not illustrated) that is configured to fit into the track 140 and enable the cap 200 to rotate about the base 100 while remaining secured to the base 100. The cap 200 can be rotated between an open position A (illustrated in FIG. 1) and a closed position B (illustrated in FIG. 3). The cap 200 further includes an opening 210 that has a size and shape similar to that of the channel 110 of the base 100. The opening 210 of the cap 200 has a curvature that mirrors the curvature of the channel 110 and the edge of the base 100. Moreover, the cap 200 includes a hood 220 proximate to the end of the opening 210 that is positioned proximate to the aperture 130 of the base 100 when the cap 200 is in the open position A. In addition, the cap 200 includes a plurality of grip portions 240 along the edge of the cap 200. These grip portions 240 are sized to partially receive a user's fingers, providing grip when rotating the cap 200 about the base 100. In other embodiments, the number of grip portions 240 located on the cap 200 may be greater or fewer. Furthermore, the cap 200 may not contain grip portions 240 at all.

As stated previously, the cap 200 of the infant cup lid 10 can be selectively configured by a user in an open position A, illustrated in FIG. 1, and a closed position B, illustrated in FIG. 3. When the cap 200 is configured in the open position A, the straw 300 is in fluid communication with the cup 400 to which the infant cup lid 10 is attached. A user can provide suction to the straw 300 and fluid from within the cup 400 will be drawn through the straw opening 310 (shown in FIG. 2). As the cap 200 is rotated clockwise, the hood 220 of the cap 200 contacts the straw 300, bending the portion of the straw 300 that extends from the top of the base 100 against the ramp 120 of channel 110 of the base 100. Rotating the cap 200 clockwise from open position A to closed position B causes the straw to be crimped or pinched by the edge of the aperture 130, the ramp 120, and the cap 200. This causes the straw 300 to bend and form a seal, closing the straw, and preventing the contents of the cup 400 from spilling or leaking out of the straw 300 and the cup 400. Additionally, the straw 300 is formed of a material designed to bend repeatedly without breaking, cracking, or deforming permanently. To return the cap 200 to the open position A, a user rotates the cap 200 counterclockwise. In other embodiments, the cap 200 may continuously rotate clockwise or counterclockwise to move between the open position A and the closed position B.

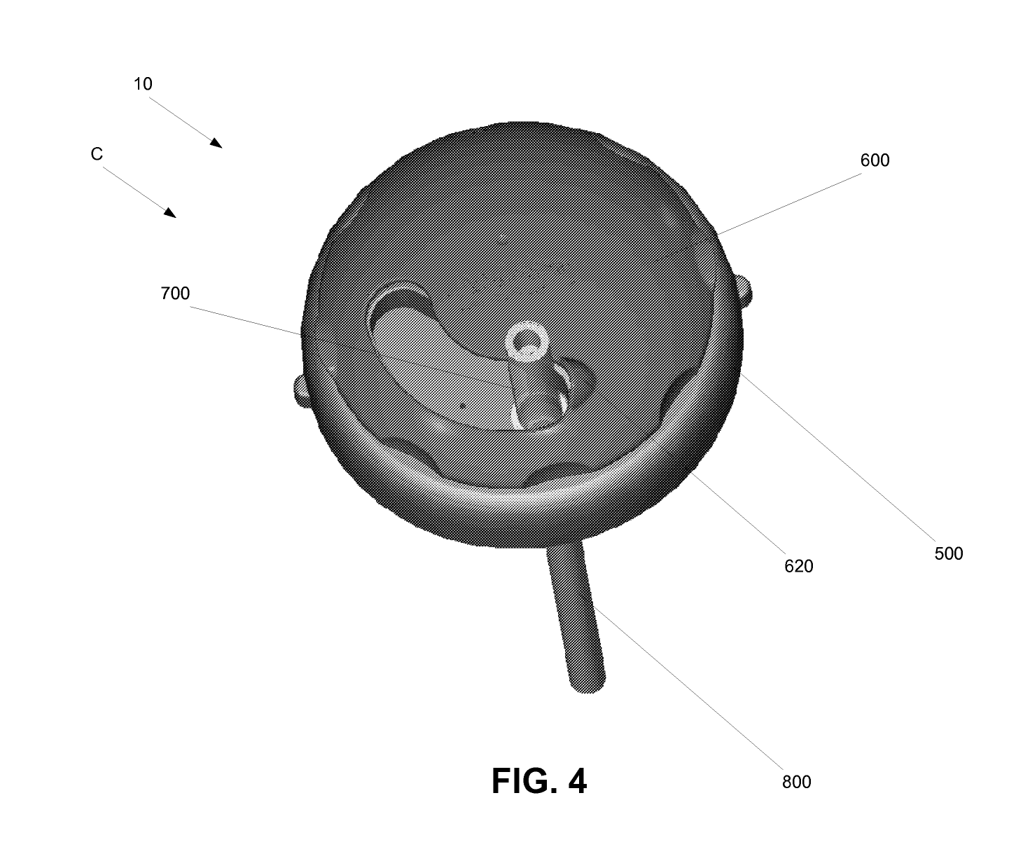

Referring to FIGS. 4, 5, 5a, 6, 6a, 7, 7a, 8, 8a, and 9, a second embodiment of the infant cup lid 10 in accordance with the present invention is illustrated. As illustrated in FIG. 4, this embodiment of the infant cup lid 10 includes a base 500, a cap 600, a straw member 700, and a straw extension 800. As later explained, the straw member 700 and cap 600 are coupled to the base 500, with the cap 600 being rotatably coupled to the base 500. The straw extension 800, as later explained, is coupled to the straw member 700. The base 500 is configured to attach to a beverage container where the straw extension 800 extends into the beverage container. When a user provides suction to the straw member 700, liquid inside the beverage container is drawn upward through the straw extension 800 and then through the base 500 and straw member 700.

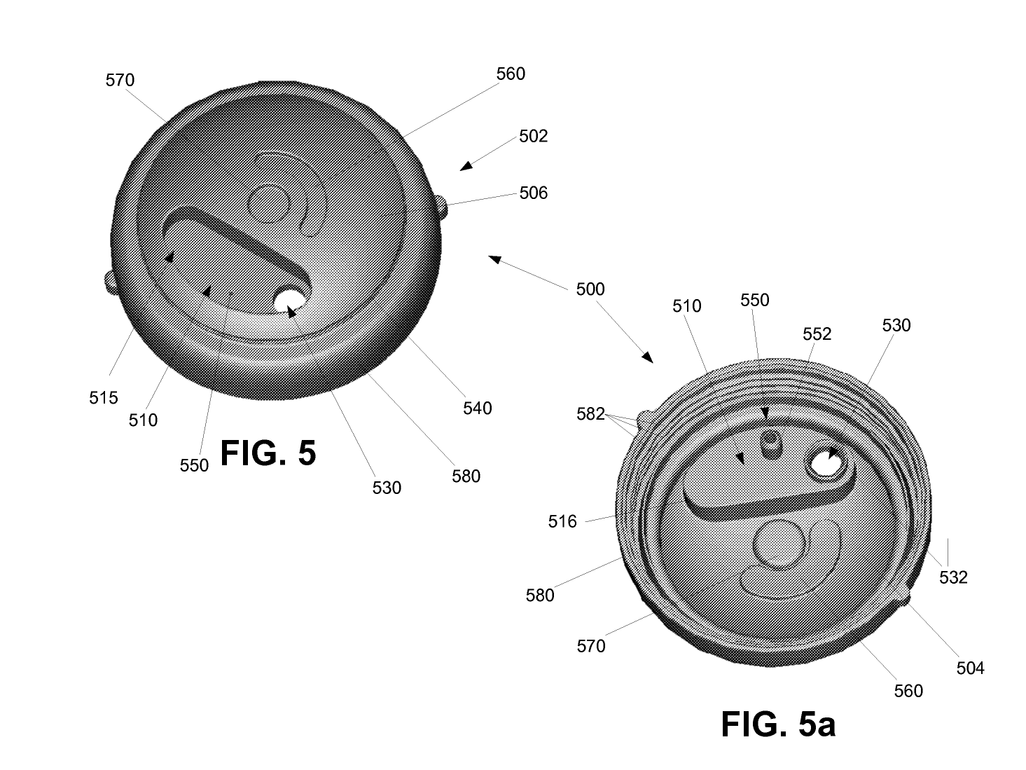

Referring to FIGS. 5 and 5a, illustrated is the base 500 of the infant cup lid 10. The base 500 has an exterior 502, illustrated in FIG. 5, and an interior 504, illustrated in FIG. 5a. The base 500 may be constructed of a substantially circular shape. The base 500 includes a top 506 on the exterior 502, with a skirt 580 that extends downward from the top 506. As illustrated in FIG. 5a, the skirt 580 includes threads 582 are may be configured to mate with external threads on the rim of a beverage container (not shown) to enable the infant cup lid 10 to be screwed onto the beverage container. In other embodiments, the infant cup lid 10 may be coupled to a beverage container via a snap fit, friction fit, or other similar means. The top 506 of the base 500 further includes a depression 570 and a curvilinear channel 560. The depression 570 may be positioned centrally on the top 506 of the base 500. Furthermore, the curvilinear channel 560 is a depressed channel in the top 506 of the base 500 that curves around a portion of the depression 570. Around the entire perimeter of the top 506 on the exterior 502 of the base 500 is a track 540. In other embodiments, the track 540 may only extend around a portion of the top 506.

In addition, the top 506 may also include a cavity 510. In this embodiment, the cavity 510 is a portion of the top 506 that has been lowered into the interior 502 of the base 500. The cavity 510 may be positioned on the base 500 so the cavity 510 is offset from the center of the base 500. Moreover, the cavity 510 has one side that is straight and another side that is curved to match the curvature of the edge of the top 506 of the base 500. The cavity 510 includes an aperture 530 and an air vent 550. As illustrated in FIG. 5a, the cavity 510, depression 570, and channel 560 all extend from the top 506 of the base 500 into the interior 504 of the base 500. The depression 570 and channel 560 extend an equal distance into the interior 504. However, as illustrated in FIG. 5a, the cavity 510 extends farther into the interior 504 than the depression 570 and the channel 560. As further illustrated by FIG. 5a, the aperture 530 includes a collar 532 that extends further into the interior 504 from the bottom of the cavity 510. Similarly, the air vent 550 includes an extension 552 that extends from the edges of the air vent 550 further into the interior 504 from the bottom of the cavity 510. Note that the cavity 510 may be sloped in depth. Thus, first end 515 (see FIG. 5) of the cavity 510 may be more shallow (at a higher height with respect to a supporting surface such as a tabletop) than the second end 516 (see FIG. 5a) of the cavity 510.

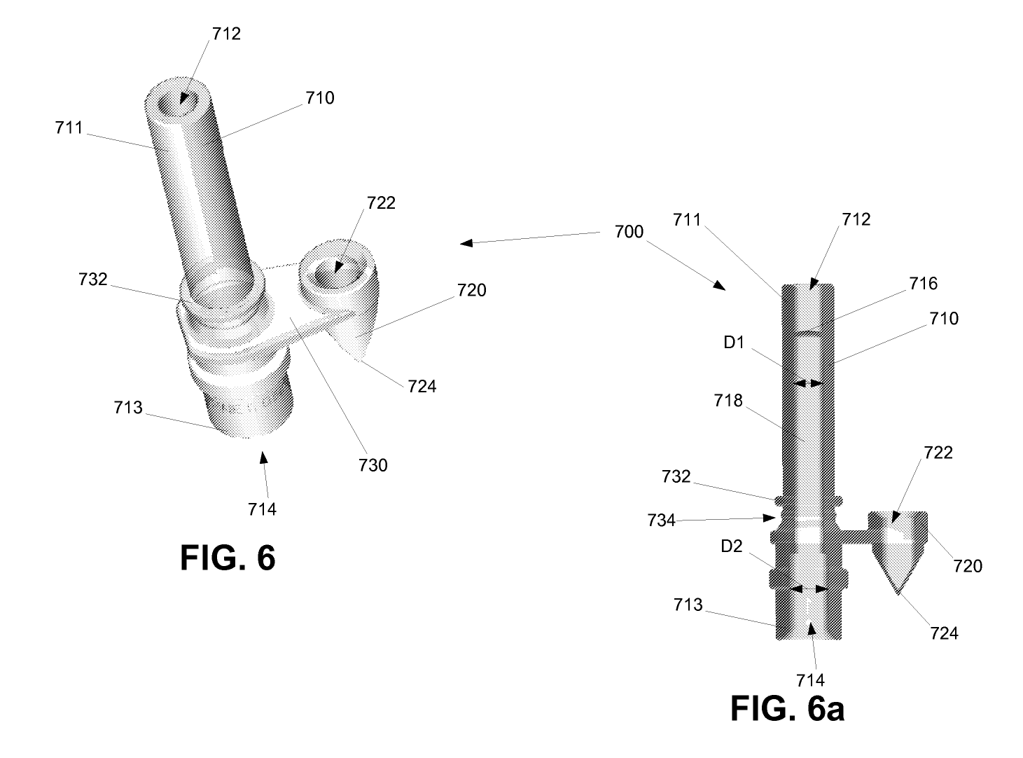

Referring to FIGS. 6 and 6a, illustrated is the straw member 700. The straw member 700 includes a straw 710, an air valve 720, and a bridge member 730 that couples the straw 710 and the air valve 720 to each other. As illustrated, the straw 710 includes a top 711 and a bottom 713. The bottom 713 of the straw 710 includes an inlet 714, while the top 711 of the straw 710 includes an outlet 712. Furthermore, the straw 710 includes a conduit 718 extending from the inlet 714 to the outlet 712, fluidly connecting the inlet 714 and the outlet 712. As best illustrated in FIG. 6a, the conduit 718 has a first inner diameter D1 and a second inner diameter D2. The first diameter D1 is smaller than the second inner diameter D2. In this embodiment, a large portion of the conduit 718 has an inner diameter of the first inner diameter D1, with a small portion of the conduit 718, the portion proximate to the bottom 713 of the straw 710, having an inner diameter of the second inner diameter D2. The second inner diameter D2 is configured to receive a portion of the straw extension 800, where the straw extension 800 is frictionally fit within the outlet 714 of the bottom 713 of the straw 710. In addition, within the conduit 718, proximate to the top 711 of the straw 710 is a valve member 716. The valve member 716 is configured to regulate the flow of fluid from within a beverage container to which the infant cup lid 10 is attached. The valve member 716 may contain one or more slits that are configured to deform when a pressure is applied to the straw 710. In other embodiments, the valve member 716 may be positioned within the conduit 718 at a different location, such as proximate to the bottom 713 of the straw 710 or equidistant from the top 711 and bottom 713 of the straw 710.

As previously explained, connected to the straw 710, by the bridge member 730, is the air valve 720. The bridge member 730 is a substantially planner member. The straw additionally includes a flange 732 that extends from the outer surface of the straw 710. Furthermore, the flange 732 is positioned on the straw 710 a distance above the bridge member 730 to create a gap 734. Regarding the air valve 720, the air valve 720 includes an inlet 722 and a valve apex 724. As best illustrated in FIG. 6a, the air valve 720 has a cross-section that forms a substantially V-shape with the valve apex 724 being at the bottom of the air valve 720. The valve apex 724 is configured to deform into an opening when a pressure is applied, allowing air to flow into the inlet 722, through the opening formed by the valve apex 724, and into a beverage container to which the infant cup lid 10 is coupled. In this embodiment, the entire straw member 700, including the straw 710, the air valve 720, and the bridge member 730, is constructed of a material designed to bend repeatedly without breaking, cracking, or deforming permanently. More specifically, the straw member 710 may be constructed from a soft thermoplastic elastomer. In other embodiments, only the straw 710, the valve member 716, and the valve apex 724 of the air valve 720 may be constructed from flexible, non-rigid materials, such as a soft thermoplastic elastomer.

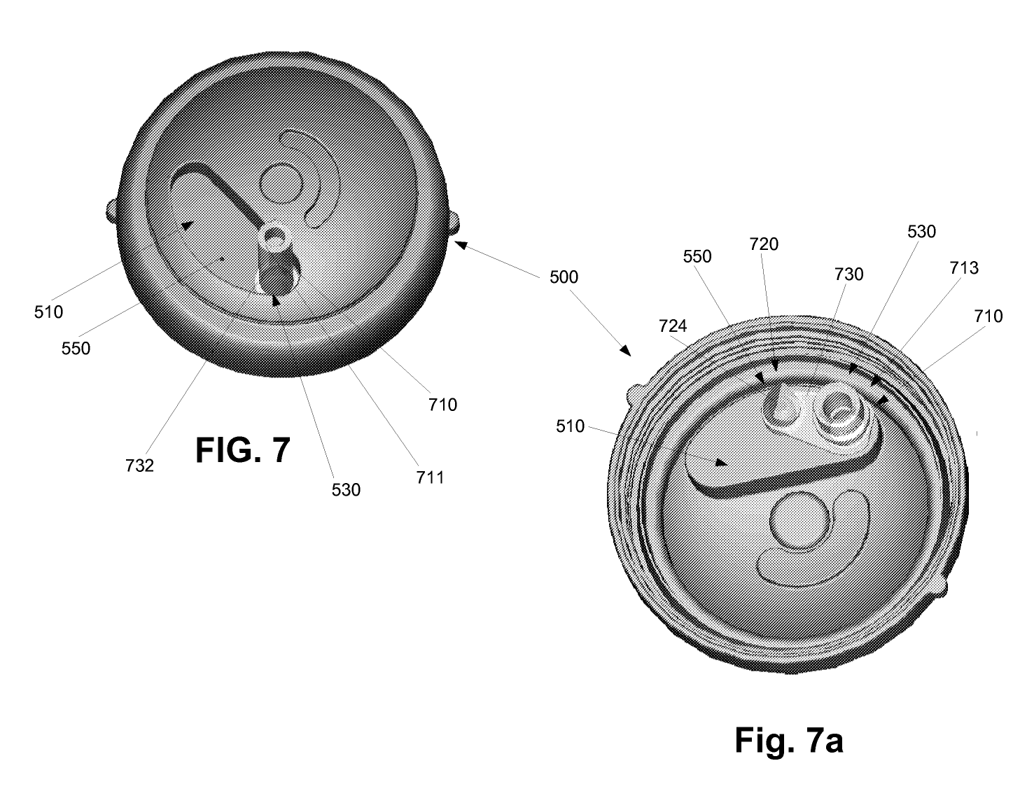

As best illustrated by FIGS. 7 and 7a, the straw member 700 is coupleable to the base 500. As illustrated in FIG. 7, the top 711 of the straw 710 is configured to extend upwardly through the aperture 530 of the cavity 510 of the base 500. Furthermore, the flange 732 is configured to be wider than the aperture 530 of the cavity 510, preventing the straw 710 from sliding downwardly through the aperture 530. Turning to FIG. 7a, while the straw 710 is configured to extend upwardly through the aperture 530 of the cavity 510, the air valve 720 is coupled to the extension 552 of the air vent 550. As illustrated, the air vent 550 and the aperture 530 are spaced apart from each other the same distance that the straw 710 and the air valve 720 are spaced apart from each other by the bridge member 730. The extension 552 of the air vent 550 is configured to frictionally fit within the inlet 722 of the air valve 720, enabling the air valve 720 to be in fluid communication with the air vent 550. Moreover, the bridge member 730 is configured to abut the collar 532 of the aperture 530, so that the aperture 530 of the cavity 510 is positioned in the gap 734 between the flange 732 and the bridge member 730.

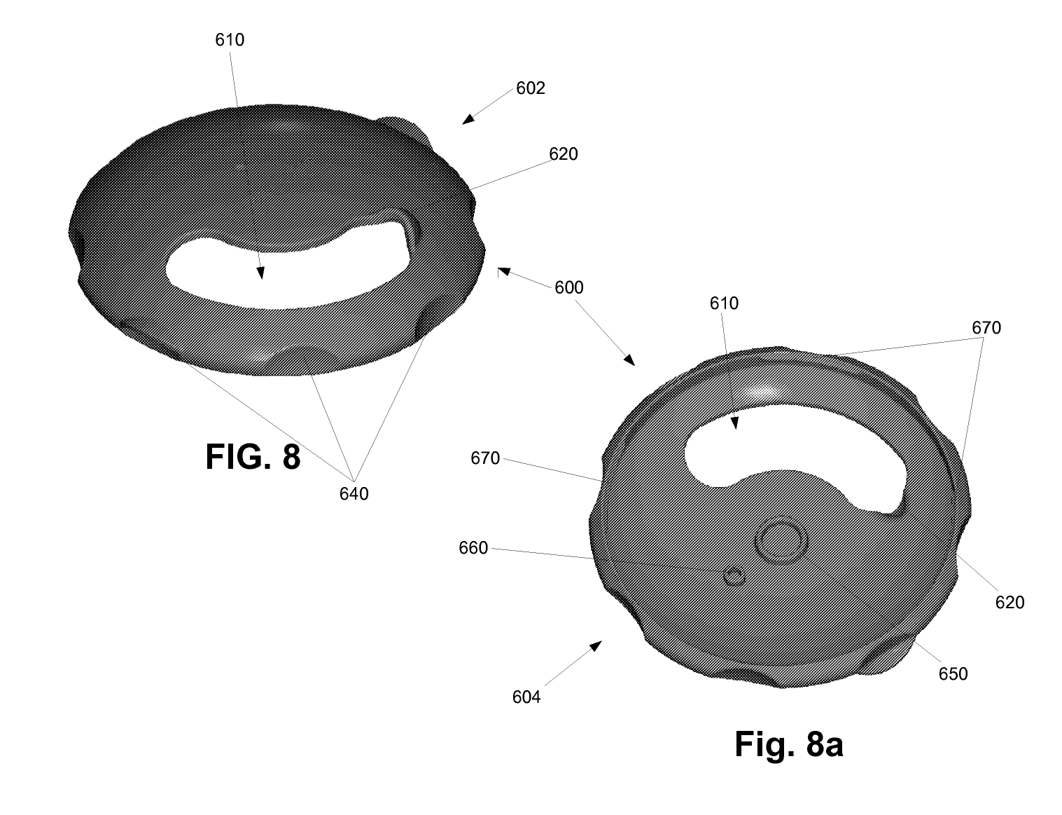

Referring to FIGS. 8 and 8a, illustrated is the cap 600 of the second embodiment of the infant cup lid 10. The cap 600 is configured to be rotatably coupled to the top 506 of the base 500, with the cap 600 covering a substantial portion of the top 506 of the base 500. The cap 600 has a top 602 and a bottom 604. The cap 600 further includes an opening 610 that extends through the cap 600 from the top 602 to the bottom 604. The opening 610 of the cap 600 has a curvature that mirrors the curvature of the curved side of the cavity 510 and the edge of the base 500. Moreover, the cap 600 includes a hood 620 proximate to one end of the opening 610. In addition, the cap 600 includes a plurality of grip portions 640 along the edge of the cap 600. These grip portions 640 are sized to partially receive a user's fingers, providing grip when rotating the cap 600 about the base 500. In other embodiments, the number of grip portions 640 located on the cap 600 may be greater or fewer than the number illustrated in FIG. 8. Furthermore, the cap 600 may not contain any grip portions 640 at all.

As best illustrated in FIG. 8a, the bottom 604 of the cap 600 includes track runners 670 that are configured to fit into the track 540 of base 500 (see FIG. 5) and enable the cap 600 to rotate about the base 500 while remaining secured to the base 500. The cap 600 includes three track runners 670 spaced equally around a part of the perimeter of the bottom 604 of the cap 600. In other embodiments, the number of track runners 670 may be greater or fewer than three. As further illustrated in FIG. 8a, the bottom 604 of the cap 600 includes a guide 660 and a projection member 650. The projection member 650 and the guide 660 extend from the bottom 604 of the cap 600. Moreover, the projection member 650 is centrally placed on the bottom 604 of the cap 600. The guide 660 is positioned on the bottom 604 of the cap 600 at a location offset from the center of the bottom 604 of the cap 600, but in close proximity to the projection member 650. Both the guide 660 and the projection member 650 are circular in shape, with the projection member 650 having a larger diameter than the guide 660.

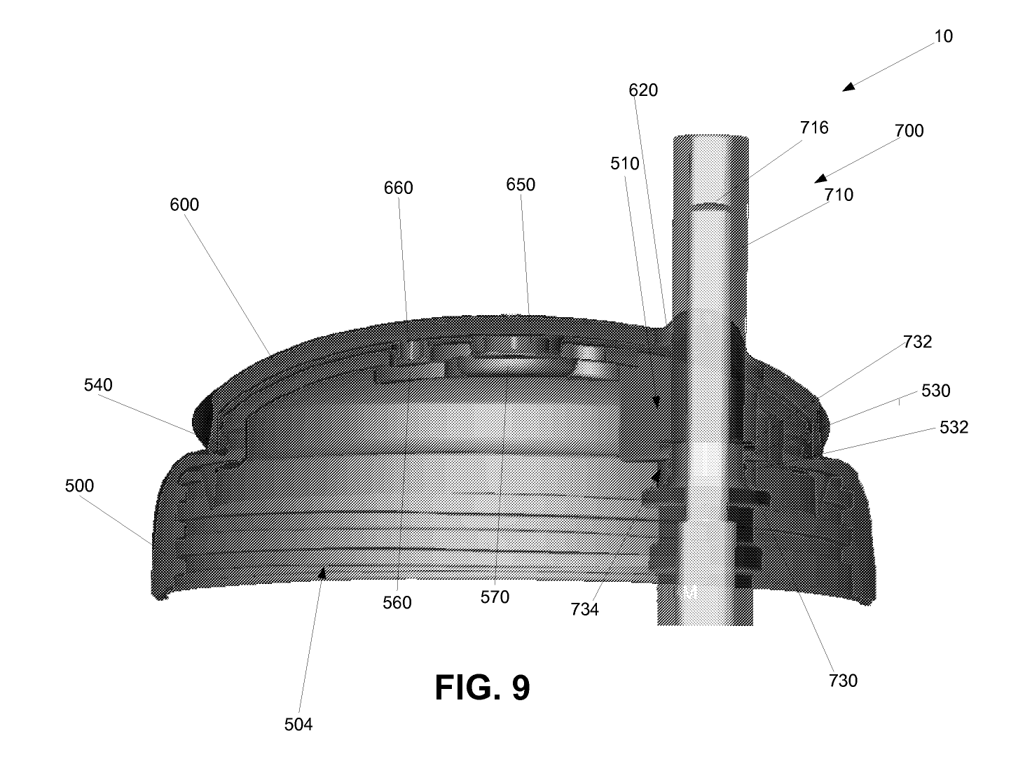

Turning to FIG. 9, illustrated is a cross-sectional view of the infant cup lid 10 of FIG. 4. As illustrated, the cap 600 is coupled to the top 506 of the base 500. When the cap 600 is coupled to the base 500, the projection member 650 is inserted into the depression 570, which extends into the interior 504 of the base 500. Moreover, the projection member 650 is sized and shaped similar to the depression 570. As previously explained, for this embodiment, the projection member 650 and the depression 570 are circular in shape. Additionally, when the cap 600 is coupled to the base 500, the guide 660 is configured to be inserted into the channel 560, which extends into the interior 504 of the base 500. The guide 660 is spaced from the projection member 650 the same distance that the channel 560 is spaced from the depression 570. When the cap 600 rotates on the base 500, the projection member 650 is configured to rotate within the depression 570, while the guide 660 is configured to slide/translate from one side of the channel 560 to the other side of the channel 560. The guide 660 is positioned on one side of the channel 560 when the cap 600 is in the open position C (illustrated in FIG. 4) and on the other side of the channel 560 when the cap 600 is in the closed position D (not illustrated for this particular embodiment, but substantially similar to the position shown in FIG. 3).

Continuing with FIG. 9, illustrated is the straw member 700, specifically the straw 710, extending through the aperture 530 of the cavity 510. As previously explained, the collar 732 extends from the straw 710 on the upper side of the aperture 530 within the cavity 510. The collar 732 prevents the straw 710 from moving downwardly through the aperture 530. Furthermore, the bridge member 730 is positioned flush against the collar 532 of the aperture 530. Positioned within the gap 734, which is located between the bridge member 730 and the collar 732, is the collar 532 and the aperture 530. Moreover, the straw 710 is configured to extend upwardly from the aperture 530 of the cavity 510 through the opening 610 in the cap 600. As illustrated by FIGS. 4 and 9, the hood 620 is positioned adjacent the straw 710 when the cap 600 is in the open position C. As the cap 600 is rotated from the open position C to the closed position D (not illustrated for this particular embodiment, but substantially similar to the position shown in FIG. 3), the hood 620 contacts the straw 710, guiding the straw down into the cavity 510. When the straw 710 is enclosed entirely within the cavity 510 by the cap 600, the straw 710 is bent at the aperture 530, which results in the straw 710 being crimped. This causes the straw 710 to bend and form a seal in the conduit 718, preventing the contents of the beverage container (not shown) from spilling or leaking out of the straw 710. Additionally, as stated previously, the straw 710 is formed of a material designed to bend repeatedly without breaking, cracking, or deforming permanently. Also previously explained, the straw 710 includes a valve 716 positioned within the conduit 718 to prevent liquid from leaking out of the straw 710 in addition to the crimping of the straw 710.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. An infant cup lid comprising:
a base further comprising a channel with a first end and a second end;
an aperture disposed in the second end of the channel;
a cap rotatably coupled to the base, the cap further comprising an opening; and
a straw disposed through the opening in the cap and the aperture, wherein the cap rotates between an open position where the straw is configured for fluid communication with an attached cup and a closed position where the straw positioned substantially within the channel of the base and underneath the cap.

2. The infant cup lid as set forth in claim 1, wherein the first end of the channel is positioned at a first height and the second end of the channel is positioned at a second height, the first height being different than the second height.

3. The infant cup lid as set forth in claim 2, where the first height is spaced above the second height.

4. The infant cup lid as set forth in claim 1, wherein the straw further comprises:
a valve member disposed within the straw, the valve member configured to deform when a pressure is applied to the straw.

5. The infant cup lid as set forth in claim 1, wherein the opening in the cap is configured to be of a similar shape and size as that of the channel of the base.

6. The infant cup lid as set forth in claim 1, further comprising:
an air vent disposed on the base at a location different from the second end of the channel.

7. The infant cup lid as set forth in claim 1, wherein when the cap is in the closed position, the straw is bent at the aperture to seal the straw.

8. An infant cup lid comprising:
a base comprising a cavity and an aperture disposed within the cavity;
a cap rotatably coupled to the base, the cap comprising an opening; and
a straw with a distal end and a proximal end opposite the distal end, the distal end of the straw being disposed through the aperture in the base, wherein the cap rotates between an open position where the distal end of the straw extends through the opening in the cap and a closed position where the distal end of the straw is covered by the cap and positioned within the cavity of the base.

9. The infant cup lid as set forth in claim 8, further comprising:
an air vent disposed within the cavity.

10. The infant cup lid as set forth in claim 9, wherein the aperture is disposed within the cavity at a first location and the air vent is disposed within the cavity at a second location different from the first location.

11. The infant cup lid as set forth in claim 9, further comprising:
an air valve coupled to the air vent, the air vent configured to deform when a pressure is applied to the air valve.

12. The infant cup lid as set forth in claim 11, wherein the air valve is configured to extend from the air vent into the attached cup.

13. The infant cup lid as set forth in claim 11, wherein the air valve and the distal end of the straw are coupled together.

14. The infant cup lid as set forth in claim 11, wherein the air valve and the straw are constructed from a flexible and resilient material.

15. The infant cup lid as set forth in claim 8, further comprising:
a straw extension coupled to the distal end of the straw, the straw extension being in fluid communication with the straw.

16. The infant cup lid as set forth in claim 8, wherein the straw further includes an internal valve member, the valve member configured to deform when a pressure is applied to the straw.

17. The infant cup lid as set forth in claim 8, wherein the base and cap are constructed from a rigid material.

18. An infant cup lid comprising:
a base comprising an aperture, a perimeter, and a track disposed at least partially around the perimeter of the base;
a cap comprising an opening and at lease one engagement member, the cap being rotatably coupled to the base with the engagement member disposed within the track and configured to move within the track as the cap is rotated with respect to the base; and
a straw with a distal end and a proximal end opposite the distal end, the distal end of the straw being disposed through the aperture in the base, wherein the cap rotates between an open position where the distal end of the straw extends through the opening in the cap and a closed position where the distal end of the straw is positioned between the cap and the base.

19. The infant cup lid as set forth in claim 18, wherein the cap further comprises:
a perimeter with at least one indentation, the at least one indentation being configured to receive a user's finger and provide grip to rotate the cap.

20. The infant cup lid as set forth in claim 19, wherein cap further comprises:
a hood disposed proximate the opening, the hood being configured to engage the straw when the cap is being rotated from the open position to the closed position.
